(19) United States
(12) Patent Application Publication
(10) Pub. No.: US 2026/0289644 A1
(43) Pub. Date: Sep. 24, 2026

(54) INFORMATION PROVISION DEVICE, INFORMATION PROVISION METHOD, AND RECORDING MEDIUM

(71) Applicant: NEC Corporation, Tokyo (JP)

(72) Inventor: Junichiro GOTO, Tokyo (JP)

(73) Assignee: NEC Corporation, Tokyo (JP)

(21) Appl. No.: 19/475,564

(22) PCT Filed: May 8, 2023
(86) PCT No.: PCT/JP2023/017302

§ 371 Date: Oct. 15, 2025

(51) Int. Cl. G06Q 30/0601; G06T 7/70; G06V 20/52

(52) U.S. Cl. CPC G06Q 30/06311; G06Q 30/0625; G06T 7/70; G06V 20/52; G06T 2207/30242; G06V 2201/07

(57) ABSTRACT

This information provision device includes: one or more memories storing instructions; and one or more processors configured to execute the instructions to: acquire an image in which a selling area where a commodity is sold is captured; detect a customer in the selling area based on the image; specify, based on detection results in a prescribed period up to the present, a customer staying degree corresponding to at least one of the number of times a customer stays, a staying time, and the number of staying customers; specify a position at which the staying degree satisfies a prescribed condition; and output recommendation information indicating that a section around the position in the selling area is attracting attention.

### TECHNICAL FIELD

The present disclosure relates to an information provision device, an information provision method, and a recording medium.

### BACKGROUND ART

There is a technology of displaying an advertisement to a customer.

PTL 1 discloses a customer information collection system that captures a trend of a customer traveling in front of a product shelf, determines a content to be provided to the customer based on the trend of the customer, and provides a video or sound that attracts the customer.

### CITATION LIST

### Patent Literature

PTL 1: JP 2021-131786 A

### SUMMARY OF INVENTION

### Technical Problem

Meanwhile, a customer may determine a product to purchase based on product information such as information indicating a popular product and a recommended product, and information describing the product.

However, in an unmanned store where no clerk is present, the customer cannot hear product information from the clerk.

An example of an object of the present disclosure is to provide a technology capable of providing information for a customer to select a product in a sales room with a simple configuration.

### Solution to Problem

An information provision device according to one aspect of the present disclosure includes acquisition means for acquiring an image capturing a sales room for selling a product, customer detection means for detecting a customer in the sales room based on the image, stay degree specification means for specifying a degree of stay of the customer according to at least one of the number of stays, a staying time length, and the number of staying customers based on a detection result in a predetermined period up to the present, position specification means for specifying a position where the degree of stay satisfies a predetermined condition, and output means for outputting recommendation information indicating that a section around the position in the sales room is attracting attention.

An information provision method according to one aspect of the present disclosure, causes a computer to perform acquiring an image capturing a sales room for selling a product; detecting a customer in the sales room based on the image, specifying a degree of stay of the customer according to at least one of the number of stays, a staying time length, and the number of staying customers based on a detection result in a predetermined period up to the present, specifying a position where the degree of stay satisfies a predetermined condition, and outputting recommendation information indicating that a section around the position in the sales room is attracting attention.

An information provision program according to one aspect of the present disclosure, causes a computer to execute processing of acquiring an image capturing a sales room for selling a product, detecting a customer in the sales room based on the image, specifying a degree of stay of the customer according to at least one of the number of stays, a staying time length, and the number of staying customers based on a detection result in a predetermined period up to the present, specifying a position where the degree of stay satisfies a predetermined condition, and outputting recommendation information indicating that a section around the position in the sales room is attracting attention.

The program may be stored in a non-transitory computer-readable recording medium.

### Advantageous Effects of Invention

An example of an effect of the present disclosure is that information for a customer to select a product can be provided in a sales room with a simple configuration.

### BRIEF DESCRIPTION OF DRAWINGS

FIG. 1 is a diagram illustrating an example of a configuration of a system including an information provision device according to the present disclosure.

FIG. 2 is a diagram illustrating another example of the configuration of the system including the information provision device according to the present disclosure.

FIG. 3 is a block diagram illustrating an example of a functional configuration of the information provision device according to the present disclosure.

FIG. 4 is a diagram illustrating an output example of recommendation information according to the present disclosure.

FIG. 5 is a flowchart illustrating an example of operation of the information provision device according to the present disclosure.

FIG. 6 is a block diagram illustrating another example of the functional configuration of the information provision device according to the present disclosure.

FIG. 7 is a flowchart illustrating another example of the operation of the information provision device according to the present disclosure.

FIG. 8 is a block diagram illustrating another example of the functional configuration of the information provision device according to the present disclosure.

FIG. 9 is a diagram illustrating a hardware configuration for implementing the information provision device according to the present disclosure using a computer and peripheral devices thereof.

### EXAMPLE EMBODIMENT

The present disclosure relates to a technology for providing information to a customer in a sales room for selling a product. An information provision device, an information provision method, and a program according to the present disclosure specify a position where a degree of stay of a customer in a sales room satisfies a predetermined condition, and output recommendation information indicating that a section around the specified position is attracting attention. Here, the sales room is a place where a product is sold. In the present disclosure, a small unmanned store in which each of product sellers who are sellers of products places and sells products in a sales room is mainly assumed as the sales room. The sales room to which the information provision device or the like of the present disclosure is applied is not limited to this example, and a method of selling products in the sales room, a size of the sales room, the presence or absence of a clerk in the sales room, and the like are not particularly limited. The sales room may be a store or a part of the store.

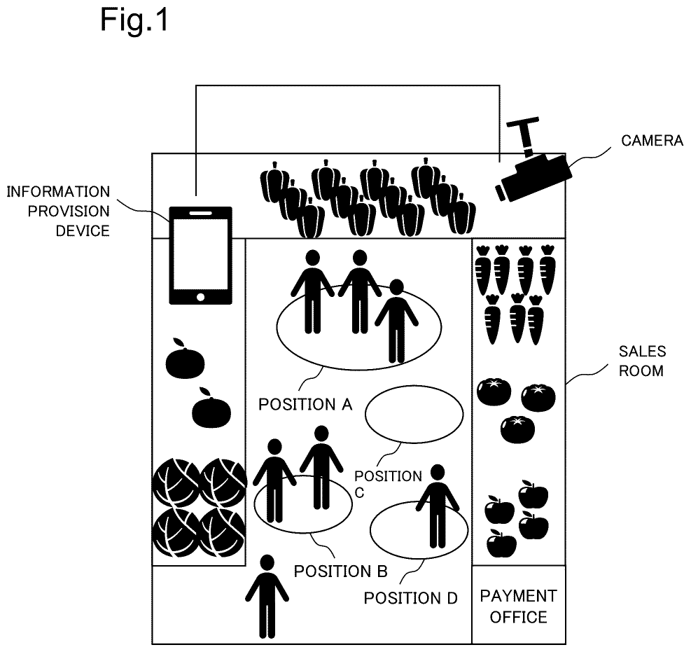

FIG. 1 is a diagram illustrating an example of a system including an information provision device according to the present disclosure. In FIG. 1, the information provision device is a terminal device installed in a sales room. The information provision device includes at least one of sound output means and display means, and outputs recommendation information. The information provision device may include a camera that images the sales room. Alternatively, the information provision device may be communicably connected to a camera that images the sales room. Although details will be described later, the information provision device acquires an image capturing the sales room from the camera, and specifies the degree of stay of the customer based on the image. Then, the information provision device outputs recommendation information indicating that a section around a position where the degree of stay of the customer satisfies a predetermined condition is attracting attention using the sound output means or the display means.

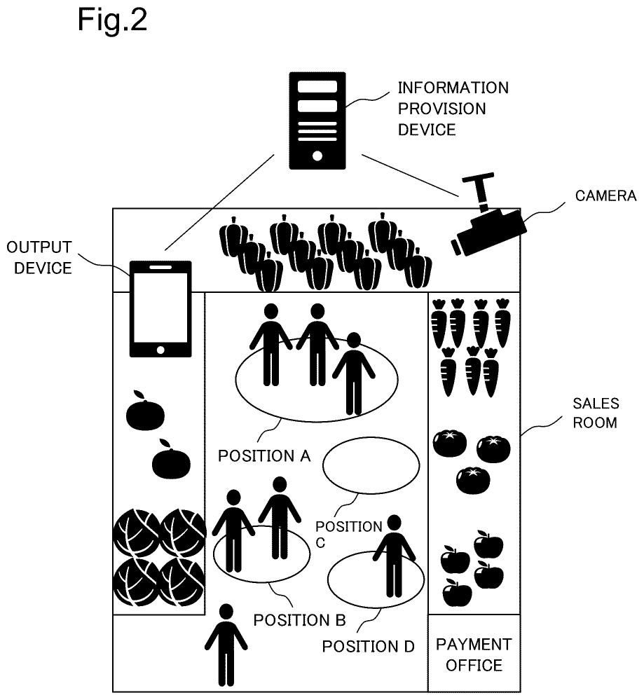

FIG. 2 is a diagram illustrating another example of the system including the information provision device according to the present disclosure. In FIG. 2, the information provision device is an output device installed in the sales room and a server connected to the camera.

The output device may be at least one of a sound output device and a display device. The output device and the camera may be one terminal device. Although details will be described later in the example embodiment similarly to FIG. 1, the information provision device acquires an image capturing a sales room from the camera, and specifies the degree of stay of a customer based on the image. Then, the information provision device causes the output device to output recommendation information indicating that a section around a position where the degree of stay of the customer satisfies a predetermined condition is attracting attention.

In FIGS. 1 and 2, persons in the sales room indicate the degree of stay of the customers at each position in the sales room. The degree of stay is a degree indicating the degree of stay of the customer in the sales room. Staying of a customer means that the customer stays at the same position for a certain period or more. Staying at the same position may be staying within a range in which the customer is assumed to be looking at the same product, and even if the customer moves within the range in which the customer is assumed to be looking at the same product, the customer may stay at the same position, that is, the customer may stay. At this time, a certain period of time for which it is determined that the customer is staying may be a period of time for which it is assumed that the customer is highly likely to pay attention to a specific product, and may be appropriately determined, for example, 10 seconds, 15 seconds, 30 seconds, 1 minute, or the like. In FIGS. 1 and 2, the degree of stay of the customer may be a stay level associated with the number of staying customers. In FIGS. 1 and 2, it is indicated that a stay level of the customer is 3 at a position A, a stay level of the customer is 2 at a position B, a stay level of the customer is 0 at a position C, and a stay level of the customer is 1 at a position D. The information provision device according to the present disclosure may output, for example, recommendation information indicating that a section around the position A where the degree of stay of the customer is the highest is attracting attention. For example, the information provision device according to the present disclosure may output recommendation information indicating that a section around each of the position A, the position B, and the position D where the degree of stay of the customer is higher than the position C is attracting attention.

The positions and the number of product shelves, products, devices, payment offices, and the like in the sales room, a method of classification and a method of display of each section recommended by each position for specifying the degree of stay and the recommendation information, a way of representing the degree of stay of the customer, and the like are not limited to the examples of FIGS. 1 and 2.

Next, example embodiments of the present disclosure will be described in detail with reference to the drawings.

### First Example Embodiment

A configuration of an information provision device 100 according to a first example embodiment will be described.

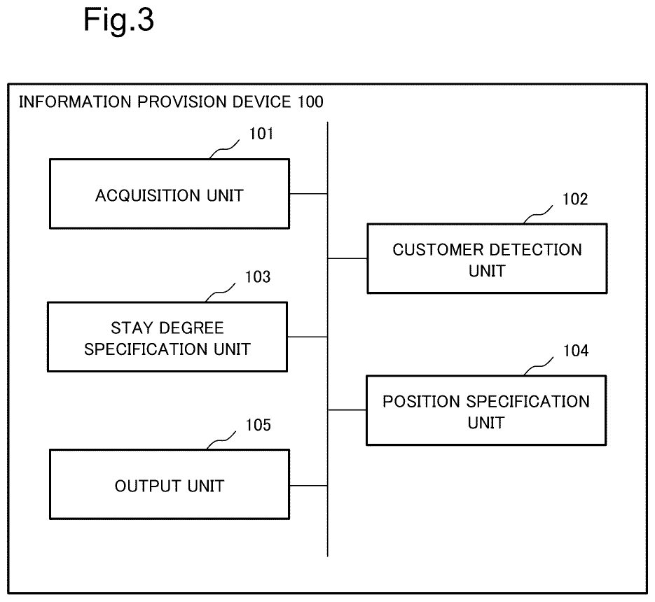

FIG. 3 is a block diagram illustrating a configuration of the information provision device 100 according to the first example embodiment. Referring to FIG. 3, the information provision device 100 includes an acquisition unit 101, a customer detection unit 102, a stay degree specification unit 103, a position specification unit 104, and an output unit 105.

Next, a configuration of the information provision device 100 according to the first example embodiment will be described in detail.

An acquisition unit 101 is an example of acquisition means for acquiring an image capturing a sales room for selling products. In a case where the information provision device 100 is a terminal device including a camera, the acquisition unit 101 acquires an image capturing the sales room from the camera included in the terminal device. In a case where the information provision device 100 is the terminal device or a server connected to the camera, the acquisition unit 101 acquires the image capturing the sales room by the camera.

The camera may capture at least an area in which products are displayed in the sales room and the customers go around looking at the products, that is, the customers move around while shopping in the sales room. The image capturing the sales room at a certain point in time may be a plurality of images capturing a part of the sales room at a certain point in time.

A customer detection unit 102 is an example of customer detection means for detecting the customers in the sales room based on the image acquired by the acquisition unit 101. The customer detection unit 102 may detect a person included in the image by a known method. In a case where the sales room is an unmanned store without a clerk, the person detected from the image capturing the sales room is a customer. Even in a case where there is a person other than the customer such as a person who carries the products into the sales room or a clerk, the person detected from the image capturing the sales room may be regarded as a customer. For example, in a case where the number of persons who carry the products into the sales room or the number of clerks is smaller than the number of customers, persons detected from the image capturing the sales room may be regarded as customers. In a case where there is a person other than the customer such as a person who carries the products in the sales room or a clerk, the customer detection unit 102 may exclude the person other than the customer from the persons detected from the image capturing the sales room. For example, in a case where the customer detection unit 102 detects an operation such as putting out products performed by a person other than the customer or an object such as an employee ID card worn by a person other than the customer, the customer detection unit 102 may exclude the person and detect the remaining person as the customer.

A stay degree specification unit 103 is an example of stay degree specification means for specifying the degree of stay of the customer according to at least one of the number of stays, a staying time length, and the number of staying customer based on a detection result of a predetermined period up to the present by the customer detection unit 102. The number of stays is the number of times the customer stays for a certain period or more (total count) in a predetermined period. The staying time length is the total time of the time during which the customer stayed in a predetermined period. The number of staying customer is the number of customers (unique count) staying for a certain period or more in a predetermined period.

The predetermined period may be an appropriate period for outputting the recommendation information to be described later. For example, the predetermined period may be a period in which the product lineup is considered to be relatively close. That is, the stay degree specification unit 103 specifies the degree of stay of the customers in the sales room based on the detection result in a period in which the product lineup is considered to be relatively close. For example, in a case where the sales room is a sales room that displays products brought by a product producer or a manufacturer, such as a vegetable direct selling store, the product selection is different every day. At this time, the predetermined period may be, for example, within the day. As a result, even in a case where the product to be sold in the sales room is a product that can be sold for a short period of time, such as vegetables, and the product is replaced early, it is possible to provide information for the customer to appropriately select the product according to the information on the product at that time. For example, in a case where the sales room is a sales room that displays products brought by product producers or manufacturers, such as a vegetable direct selling store, it is assumed that products are displayed in an amount that can be sold out. At this time, the predetermined period is, for example, the latest 15 minutes, 30 minutes, 1 hour, or the like. The predetermined period may be changed according to a time slot. For example, in a time slot in which many customers come, such as after opening the sales room or in lunch time, since products are often purchased and the product lineup in the time slot tends to change, the predetermined period may be set to be short, and the predetermined period may be set to be long in other time slots. The current time may be a time point at which the latest image among the images acquired by the acquisition unit 101 is captured. That is, the stay degree specification unit 103 specifies the degree of stay of the customer in the latest predetermined period.

As described above, the degree of stay is a degree indicating the degree of stay of the customer in the sales room. The degree of stay is determined by the number of stays, a staying time length, or the number of customers staying in the sales room. The degree of stay is represented by, for example, a plurality of levels. The level indicating the degree of stay is, for example, level 1 if the number of stays is 5 to 9, level 2 if the number of stays is 10 to 14, and the like. The criteria of the leveling may be appropriately determined according to the degree of stay in the sales room or the like. The degree of stay may be a level determined by a combination of any of the number of stays, the staying time length, and the number of customers staying in the sales room. The method of expressing the degree of stay is not limited to the above-described level. For example, the degree of stay may be the number of stays, the staying time length, or the number of customers staying in the sales room itself.

The stay degree specification unit 103 specifies the degree of stay at each position in the sales room based on the detection result in the predetermined period up to the present by the customer detection unit 102. The position in the sales room for specifying the degree of stay may be an area of a position where the products looked at by the customer are assumed to be the same in the sales room. The position in the sales room for specifying the degree of stay may be a section in the sales room recommended in the recommendation information to be described later, and may be appropriately determined. The section in the sales room is a part of the sales room. For example, the position in the sales room may be represented by a pixel in the image, or may be represented by an area of pixels in the image.

A position specification unit 104 is an example of position specification means for specifying a position where the degree of stay specified by the stay degree specification unit 103 satisfies a predetermined condition. The predetermined condition is a condition for determining that the degree of stay is high. That is, the position specification unit 104 specifies a position having a high degree of stay. The position specification unit 104 may specify a position where the number of stays is large, a position where a staying time length is long, or a position where the number of staying customer is large as the position where the degree of stay is high.

The predetermined condition under which the position specification unit 104 specifies the position will be described. The position specification unit 104 may specify a position where the degree of stay is equal to or greater than a threshold. At this time, the position specification unit 104 may specify a plurality of positions where the degree of stay is equal to or greater than the threshold. Alternatively, the position specification unit 104 may specify a position where the degree of stay is relatively high. At this time, the position specification unit 104 may specify a predetermined number of positions in descending order of the degree of stay.

In a case of specifying a position satisfying a predetermined condition, the position specification unit 104 may specify a position where the degree of stay satisfies a predetermined condition by excluding at least one of a position around a payment office where the customer pays for a product and a position around a terminal device (the information provision device 100 or an output device connected to the information provision device 100) used by the customer. This is because the position specification unit 104 specifies a position at which it is indicated that attention is paid in the recommendation information output by the output unit 105 described later. The position around the payment office where the customer pays for the product and the position around the terminal device (the information provision device 100 or the output device connected to the information provision device 100) used by the customer are positions where the customer stays in the sales room for purposes other than viewing the product. By excluding the position at which the customer stays for a purpose other than viewing the product in the sales room from a position specified for recommendation in the recommendation information, it is possible to recommend a position near a product attracting attention with higher accuracy.

An output unit 105 is an example of output means for outputting the recommendation information indicating that a section around the position in the sales room specified by the position specification unit 104 is attracting attention. The recommendation information is information indicating that the section around the specified position is attracting attention. It is estimated that there is a product that attracts the interest of the customer, that is, the customer pays attention to, around the position where many customers are staying, which is specified by the position specification unit 104. The section around the specified position may be a section including the specified position or a section of a product shelf associated with the specified position. The section of the product shelf associated with the specified position is, for example, a section of the product shelf estimated to be looked at by a customer staying at the specified position. That is, the recommendation information is information for recommending a product shelf on which a popular product is estimated to be placed to the customer. By outputting the recommendation information using the position specified based on the degree of stay, the output unit 105 can provide information to the customer without using information such as a name of the displayed product or information such as shelf allocation indicating at which position each product is displayed. The customer can obtain information for selecting a product to purchase from the products in the sales room.

For example, as an example of the sales room, there is an unmanned store in which a product seller who sells products in the sales room sells products in an unmanned store. The product seller may be a product producer or a product manufacturer. At this time, it is difficult for a business operator side providing a place or the like as an unmanned store to know products sold in the store. At this time, there is a case where it is difficult for the product seller who sells the products in such an unmanned store to provide information on the product. Therefore, it is difficult for the business operator side to provide the customer who visits the unmanned store with information on the product, and it is difficult to promote the products. Therefore, by indicating that a section around the position where the degree of stay has been specified to satisfy the predetermined condition is attracting attention, that is, by indicating a product assumed to be popular by using the position in the sales room, it is possible to provide information for the customer to select the product even in a case where the business operator side cannot recognize what the product to be sold is.

The recommendation information is information targeted for a customer who is estimated to seek information on the product to be sold in the sales room. For example, the customer estimated to seek the information on the product sold in the sales room may be a customer who has entered the sales room or a customer who is hesitating to purchase the product in the sales room. The customer hesitating to purchase the product in the sales room may be, for example, a customer staying in the sales room, a customer looking at a terminal device such as a smartphone in the sales room, or the like. The customer estimated to seek the information on the product to be sold in the sales room is not limited thereto. That is, the output unit 105 may output the recommendation information according to at least one of detection that the customer has entered the sales room, detection that the customer is staying in the sales room, and detection that the customer is looking at the terminal device used by the customer himself/herself. The detection that the customer stays in the sales room may be performed by the customer detection unit 102 using the latest image capturing the sales room. The detection that the customer stays in the sales room may be performed by another human sensor or the like connected to the information provision device 100. The detection that the customer stays in the sales room may be performed by the stay degree specification unit 103 using the latest image capturing the sales room. The detection that the customer looks at the terminal device used by the customer himself/herself may be performed by the customer detection unit 102 as long as it is detected that the customer has the terminal device or the line of sight of the customer looks at the terminal device using the latest image capturing the sales room.

The output unit 105 may output the recommendation information by display or sound. In a case where the information provision device 100 is a terminal device installed in the sales room, the output unit 105 may cause display means such as display of the terminal device, display means such as a projector communicably connected to the terminal device and installed in the sales room, a speaker installed in the terminal device, a speaker communicably connected to the terminal device and installed in the sales room, or the like to output the recommendation information. In a case where the information provision device 100 is a server communicably connected to an output device such as the terminal device installed in the sales room, the output unit 105 may cause the output device such as a display, a projector, or a speaker to output the recommendation information. The output device installed in the sales room and the terminal device including the output means may be installed around the sales room.

The output unit 105 may cause the speaker to output a sound such as “Welcome” as if the clerk serves the customer together with the recommendation information indicating that a section around the position in the sales room is attracting attention. By outputting such a sound, it is expected that there are effects such as making it easier to see the displayed recommendation information and serving as a deterrent for fraudulent acts such as shoplifting.

The output unit 105 may output preset information in a case where the position satisfying the predetermined condition is not specified. The case where the position satisfying the predetermined condition is not specified is a case where the degree of stay of the customer does not satisfy the predetermined condition for specifying the position where the popular product is estimated to be placed. The case where the degree of stay of the customer does not satisfy the predetermined condition for specifying the position where the popular product is estimated to be placed may be, for example, a case where the customer is not detected from the image capturing the sales room in the predetermined period, a case where the position where the degree of stay of the customer satisfies the predetermined condition is not specified because the number of customers detected from the image capturing the sales room in the predetermined period is small, a case where the predetermined period has not elapsed from a product display or an opening time of the sales room, or a case where the number of customers detected from the image capturing the sales room in the predetermined period is equal to or less than a predetermined number.

The information set in advance may be, for example, information for advertising the sales room, information for providing a use method of the sales room, and information for providing a use method of the terminal device. Here, the terminal device is a terminal device that outputs the recommendation information or the like output by the output unit 105, and is, for example, the information provision device 100 that is a terminal device or a terminal device connected to the information provision device 100. For example, the information set in advance may be information for recommending a product displayed in a sales room.

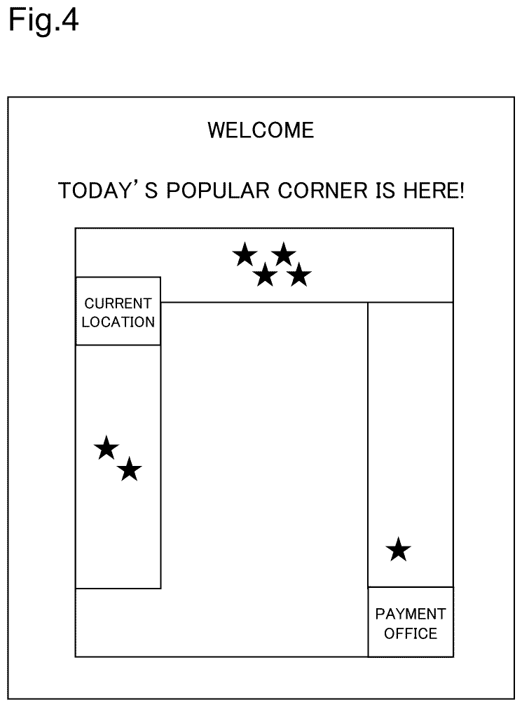

FIG. 4 is an example of an output screen for outputting the recommendation information. In FIG. 4, sections around the position specified by the position specification unit 104 are indicated as popular corners with star marks on a sales room map. In FIG. 4, three sections are shown as popular corners that are noted with star marks. In FIG. 4, the degree of popularity is indicated by the number of star marks indicating each of the three sections. That is, a section in which the number of star marks is shown to be large is a section in which the degree of stay is the highest and which is particularly popular, and a section in which the number of star marks is shown to be small is a section in which the degree of stay is the second highest and which is popular. As described above, the position specification unit 104 may specify a plurality of positions, and the output unit 105 may output the recommendation information indicating that a plurality of sections associated with the plurality of positions are attracting attention. The output unit 105 may output recommendation information indicating the degree of attention for each of the plurality of sections.

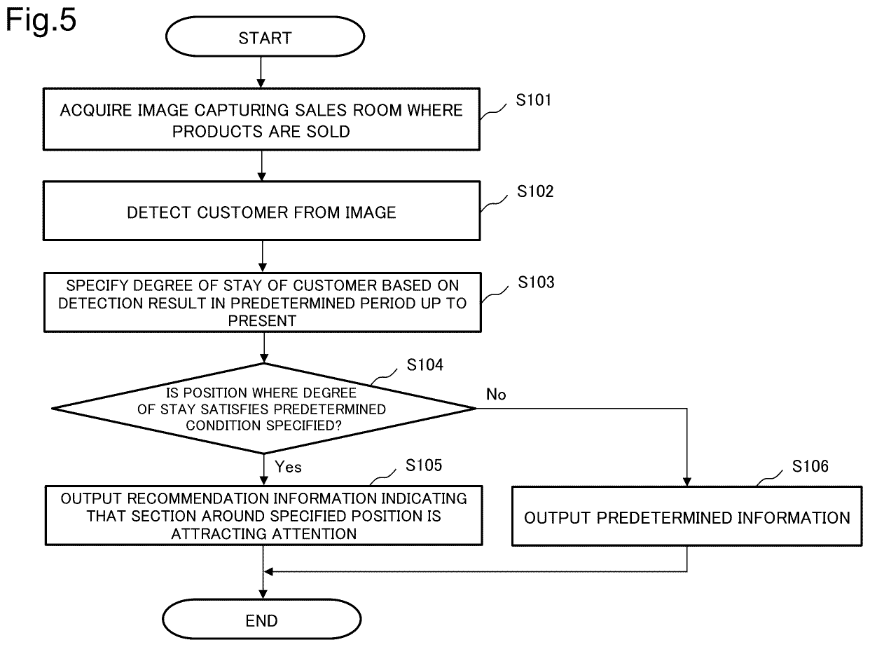

The operation of the information provision device 100 configured as described above will be described with reference to a flowchart of FIG. 5.

As illustrated in FIG. 5, first, the acquisition unit 101 acquires an image capturing a sales room for selling products (step S101).

Next, the customer detection unit 102 detects a customer from the image acquired in step S101 (step S102).

Next, the stay degree specification unit 103 specifies the degree of stay of the customer based on a detection result in a predetermined period up to the present detected in step S102 (step S103).

Next, the position specification unit 104 specifies a position where the degree of stay of the customer specified in step S103 satisfies a predetermined condition (step S104).

In step S104, in a case where a position where the degree of stay of the customer satisfies the predetermined condition is specified (step S104: Yes), the output unit 105 outputs recommendation information indicating that a section around the position specified in step S104 is attracting attention (step S105).

In step S104, in a case where the position where the degree of stay of the customer satisfies the predetermined condition is not specified (step S104: No), the output unit 105 outputs information set in advance (step S106).

As described above, the information provision device 100 ends a series of operations. Each processing of the information provision device 100 may be started in a case where a customer to be provided with information is detected, or may be started at preset time intervals.

In the information provision device according to the present example embodiment described above, the position specification unit specifies a position where the degree of stay of the customer in the sales room satisfies the predetermined condition. Then, the output unit outputs the recommendation information indicating that the section around the specified position is attracting attention in the sales room. As a result, the information provision device according to the present example embodiment can provide information for the customer to select a product in the sales room with a simple configuration.

In particular, the information provision device according to the present example embodiment outputs the recommendation information using the position in the sales room, thereby making it possible to provide information for the customer to select the product without using the product information or the shelf allocation information on the products. For example, the information provision device according to the present example embodiment can provide information for the customer to select the product even in a store that does not have product information or shelf allocation information on the products. The store that does not have the product information or the shelf allocation information on the products is, for example, a small unmanned store in which each of the product sellers who are the sales persons of the products described above places and sells the products in the sales room. The information provision device according to the present example embodiment can provide information for the customer to select the product with less camera to be used, data such as product information and shelf allocation information on the products, and processing to be performed even in a store having product information and shelf allocation information on products.

### Second Example Embodiment

Next, a second example embodiment of the present disclosure will be described in detail with reference to the drawings. Hereinafter, descriptions of contents overlapping with the descriptions above will be omitted to the extent that descriptions of the present example embodiment are not unclear.

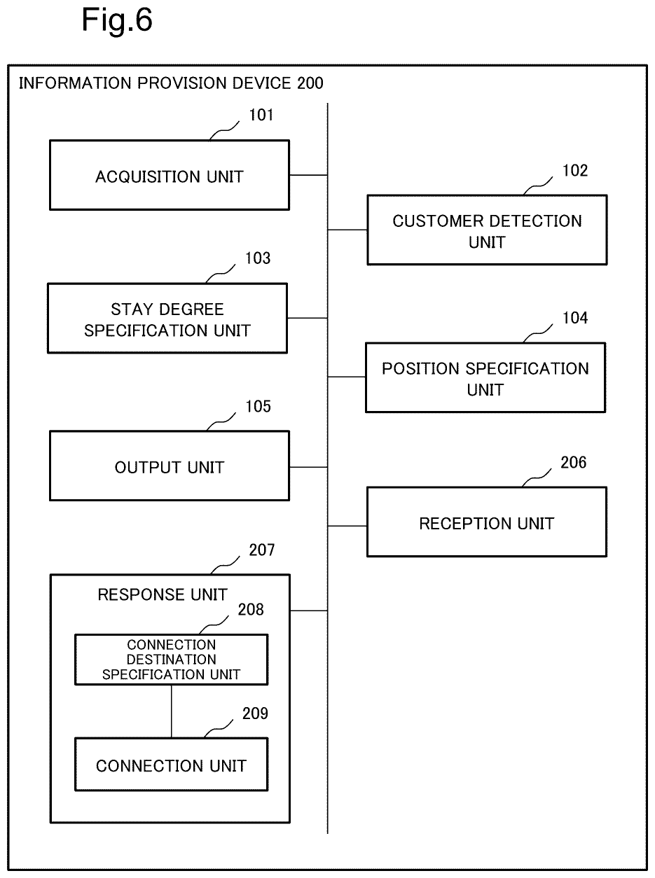

FIG. 6 is a block diagram illustrating a configuration of an information provision device according to a second example embodiment of the present disclosure. An information provision device 200 according to the second example embodiment includes a reception unit 206 and a response unit 207 in addition to the configuration of the first example embodiment.

The reception unit 206 is an example of reception means for receiving an inquiry from a customer. The reception unit 206 receives the inquiry input by the customer by input means such as a touch panel or a microphone of a terminal device that outputs recommendation information or the like output from an output unit 105. The terminal device that outputs the recommendation information and the like output from the output unit 105 is a terminal device that is the information provision device 200 or a terminal device connected to a server that is the information provision device 200. The reception unit 206 specifies an inquiry target from information input by the customer.

The response unit 207 is an example of response means for determining a response to the inquiry from the customer. The response unit 207 determines a content of the response for an inquiry target specified by the reception unit 206. The content of the response will be described later, but is either output of information regarding the inquiry target or start of connection with the product seller regarding the inquiry target.

For example, the output unit 105 displays an inquiry button for starting an inquiry together with the output recommendation information and preset information on a touch panel of the terminal device. The customer who intends to make an inquiry touches the displayed inquiry button. In a case where the inquiry button is touched, the reception unit 206 may cause the terminal device to display an inquiry target option via the output unit 105. The inquiry target option may be at least one of a location of a product shelf, a name of the product, or a name of a seller of the product. In a case where the inquiry target is selected, the response unit 207 specifies information regarding the inquiry target stored in a storage unit to be described later in association with information indicating the inquiry target. Then, the output unit 105 outputs information regarding the specified inquiry target.

In a case where the inquiry target is selected, the reception unit 206 may cause the terminal device to display an option of content desired to be inquired about the inquiry target via the output unit 105. An option of the content desired to be inquired may be product introduction, a product cooking method, or the like. In a case where content desired to be inquired about an inquiry target is selected, the response unit 207 specifies information regarding the inquiry target according to the content desired to be inquired. Then, the output unit 105 outputs information regarding the inquiry target specified by the response unit 207.

For example, the reception unit 206 may receive an inquiry by a sound input to a microphone of the terminal device. For example, in a case of having detected a sound including preset words input to the microphone of the terminal device, the reception unit 206 may receive an inquiry. In this case, the terminal device may display words such as “I want to make an inquiry” for starting an inquiry set in advance. In a case where a preset word for starting an inquiry is detected, the reception unit 206 may cause the terminal device to output a sound for specifying an inquiry target such as “What inquiry do you want to make?” via the output unit 105. The reception unit 206 specifies the inquiry target by sound recognition from the sound input after the sound for specifying the inquiry target is output. Then, the response unit 207 specifies information regarding the inquiry target stored in a storage unit in association with the information indicating the inquiry target specified by the reception unit 206. Then, the output unit 105 may cause the terminal device to output the information regarding the inquiry target specified by the response unit 207.

Methods for receiving these inquiries may be combined. As inquiry target options, information that can be specified by the customer in the sales room, such as information described on price labels in the sales room, may be appropriately used.

The response unit 207 specifies information regarding the inquiry target specified by the reception unit 206. Then, the output unit 105 outputs information on the inquiry target, which is specified by the response unit 207. The information regarding the target is stored in a storage unit (not illustrated) in association with the information indicating the target. The storage unit (not illustrated) is a storage unit communicably connected to the inside or the outside of the information provision device 200. The response unit 207 searches the storage unit for information regarding the target associated with the information indicating the specified inquiry target, thereby specifying the information regarding the target.

Alternatively, the response unit 207 may determine, as a response to the inquiry, to establish a connection with the terminal device used by the product seller related to the received inquiry target. In other words, the connection with the terminal device used by the product seller regarding the received inquiry target is a call with the product seller regarding the inquiry target. The product seller related to the inquiry target is a product seller who sells a product that is an inquiry target, a product seller who sells a product displayed at a position that is an inquiry target, or a product seller that is an inquiry target.

At this time, the response unit 207 may include a connection destination specification unit 208 and a connection unit 209.

The connection destination specification unit 208 specifies a terminal device used by a product seller as a connection destination. For example, the connection destination specification unit 208 may specify the terminal device used by the product seller associated in advance with the information indicating the inquiry target specified by the reception unit 206. For example, the connection destination specification unit 208 may display a plurality of buttons on the terminal device, and may specify the terminal device used by the product seller associated in advance with the button selected by the customer who makes an inquiry. Here, information for identifying the product seller may be displayed on each of the plurality of buttons, or information for identifying buttons other than the information for identifying the product seller, such as A, B, C, 1, 2, and 3, may be displayed. In a case where information for identifying a button other than information for identifying a product seller, such as A, B, C, 1, 2, or 3, is displayed on a plurality of buttons, a poster or the like on which information for identifying a product seller associated with each button is separately written may be installed near the terminal device or the like.

The connection unit 209 starts connection with the terminal device specified by the connection destination specification unit 208 and used by the product seller. For example, the connection unit 209 may start connection via a telephone line using a telephone number of a terminal device used by a product seller. For example, the connection unit 209 may start connection via the Internet using an external call service or the like with a terminal device used by a product seller. In this manner, by connecting to the terminal device used by the product seller as a response to the inquiry by the customer, the information provision device 200 can provide the information regarding the product even if the information regarding the product is not prepared in advance. In particular, it is possible to reduce time and effort for preparing information by the product seller.

In a case where the information regarding the inquiry target is not stored in the storage unit, the connection unit 209 may start connection with a terminal device used by a product seller regarding the inquiry target. Alternatively, the response unit 207 may determine to output the information regarding the inquiry target in a case where the connection to the terminal device used by the product seller regarding the inquiry target cannot be started.

The connection unit 209 may store, in the storage unit, connection to a terminal device used by a product seller, that is, sound information in a call, regarding the inquired subject. Alternatively, the connection unit 209 may store, in the storage unit, text data based on sound related to the inquired target in connection with a terminal device used by a product seller. In these cases, the connection unit 209 stores sound information or text data, which is information indicating the content of the call, in the storage unit in association with the information indicating the inquiry target. The information indicating the contents of the call stored in these storage units may be output as information regarding an inquiry target in response to the subsequent inquiry. As a result, the information provision device 200 can provide the information regarding the product even if the information regarding the product is not prepared in advance. In particular, the information provision device 200 can reduce the time and effort of the product seller for preparing information. The information provision device 200 can eliminate the trouble of making the same explanation in the call by the product seller a plurality of times.

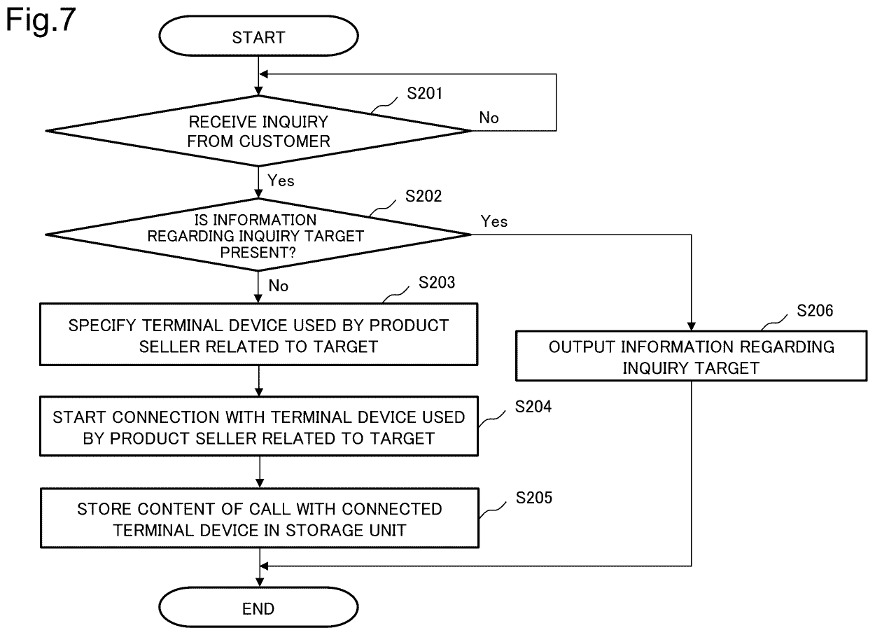

The operation in the inquiry of the information provision device 200 configured as described above will be described with reference to a flowchart of FIG. 7.

As illustrated in FIG. 7, first, the reception unit 206 receives an inquiry from a customer (step S201).

In a case where the inquiry is received from the customer in step S201 (step S201: Yes), the response unit 207 refers to the storage unit and searches for information regarding the received inquiry target (step S202).

In step S202, in a case where the information regarding the inquiry target is not stored in the storage unit (step S202: No), the response unit 207 determines, as a response to the inquiry, to establish a connection with a terminal device used by a product seller regarding the inquiry target, and the connection destination specification unit 208 specifies the terminal device used by the product seller regarding the inquiry target as a connection destination (step S203).

Next, the connection unit 209 starts connection with the terminal device used by the product seller related to the inquiry target specified in step S202 (step S204).

Next, the connection unit 209 stores sound information or text data indicating the content of a call with the connected terminal device in the storage unit (step S205).

In step S202, in a case where the information regarding the inquiry target is stored in the storage unit (step S202: Yes), the response unit 207 determines to output the information regarding the inquiry target as a response to the inquiry, and the output unit 105 outputs the information regarding the inquiry target (step S206).

As described above, the information provision device 200 ends a series of operations.

In the information provision device 200 according to the present example embodiment described above, in addition to the configuration of the information provision device 100 in the first example embodiment, the response unit 207 determines a response to an inquiry by a customer. The response unit 207 specifies information regarding an inquiry target by the customer, and the output unit 105 outputs the specified information regarding the inquiry target by the customer. Alternatively, the connection destination specification unit 208 specifies the terminal device used by the product seller related to the inquiry target, and the connection unit 209 starts connection with the terminal device used by the product seller related to the specified inquiry target.

As a result, in addition to the effects described in the first example embodiment, the information provision device according to the present example embodiment can provide more information for a customer to select a product in a sales room. For example, even in a case where the product seller cannot prepare the product information in advance, it is possible to provide more information for the customer to select the product in the sales room.

### Modification

A modification of the second example embodiment will be described.

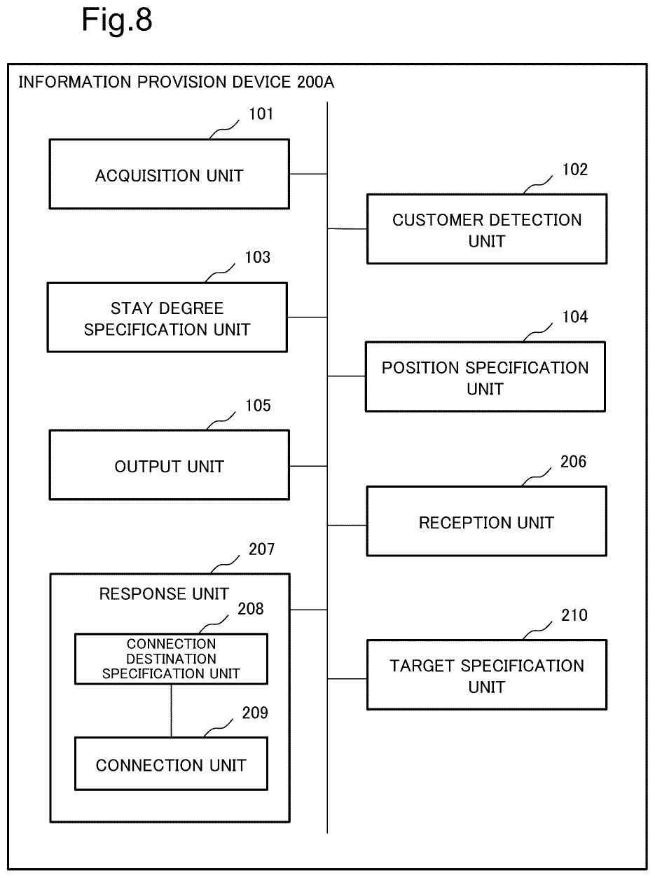

As illustrated in FIG. 8, the information provision device 200 according to the second example embodiment may be changed to an information provision device 200A further including a target specification unit 210.

The target specification unit 210 is an example of target specification means for specifying a target with a large number of inquiries from information regarding an inquiry by a customer. In this case, a response unit 207 stores information indicating the received inquiry target in a storage unit as information regarding the inquiry by the customer. The target specification unit 210 may specify a target with a large number of inquiries in a predetermined period up to the present. In this case, the response unit 207 associates the information indicating an inquiry target received with the date and time of the inquiry received, and stores the information in the storage unit as information regarding the inquiry by the customer. The date and time of the received inquiry may be a time at which the inquiry is started or a time at which the inquiry is ended.

The target specification unit 210 may specify a target for which the number of inquiries is larger than a threshold from the information regarding the inquiry by the customer. Alternatively, the target specification unit 210 may specify a target for which the number of inquiries is relatively large in a predetermined period from the information regarding the inquiry by the customer.

The target with a large number of inquiries specified by the target specification unit 210 is considered to be a target estimated to be attracting attention in the sales room, similarly to the position specified by the position specification unit 104. Therefore, the output unit 105 may output recommendation information indicating that the target with a large number of inquiries by the customer, which is specified by the target specification unit 210, is attracting attention in the sales room. In this case, the output unit 105 may output the recommendation information indicating that each of a section around a position specified by the position specification unit 104 and a target specified by the target specification unit 210 is attracting attention. A location with a large number of stays and a target with a large number of inquiries may be indicated in the same manner, such as the same mark, or may be indicated in different manners, such as different marks. In this case, in a case where the section around the position specified by the position specification unit 104 and the target specified by the target specification unit 210 match, the output unit 105 may output the recommendation information indicating that the section around the position is attracting attention. In this case, in a case where the position is not specified by the position specification unit 104, the output unit 105 may output the recommendation information indicating that the target specified by the target specification unit 210 is attracting attention. At this time, the output unit 105 may output preset information in a case where the position is not specified by the position specification unit 104 and a target with a large number of inquiries is not specified by the target specification unit 210.

According to the information provision device 200A in the modification of the second example embodiment, since the recommendation information indicating that the target is attracting attention is output using the number of inquiries in addition to the degree of stay, it may be possible to provide more information for the customer to select a product in the sales room.

### Hardware Configuration

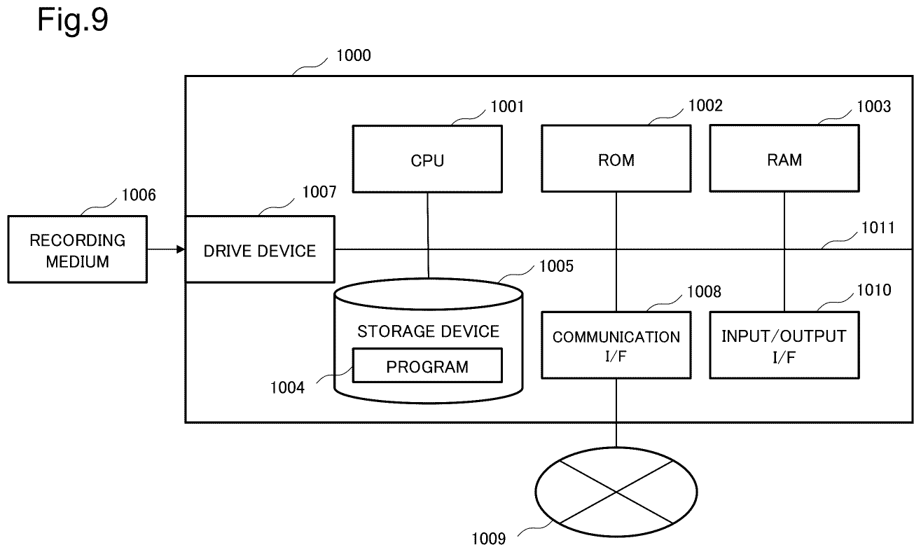

Some or all of the components of each device or system in each example embodiment of the present disclosure described above are achieved by, for example, any combination of an information processing apparatus 1000 and a program as illustrated in FIG. 9. As an example, the information processing apparatus 1000 includes the following components.
A central processing unit (CPU) 1001
A read only memory (ROM) 1002
A random access memory (RAM) 1003
A program 1004 loaded into the RAM 1003
A storage device 1005 storing the program 1004
A drive device 1007 for reading and writing a recording medium 1006
A communication I/F 1008 connected to a communication network 1009
An input/output I/F 1010 for inputting/outputting data
A bus 1011 connecting each component

I/F is an abbreviation of an interface.

Each component of each device or system in each example embodiment is achieved by the CPU 1001 acquiring and executing a program for achieving these functions. The program for achieving the function of each component of each device is stored in the storage device 1005 or the RAM 1003 in advance, for example, and is read by the CPU 1001 as necessary. The program 1004 may be supplied to the CPU 1001 via a communication network, or may be stored in advance in the recording medium 1006, and the drive device 1007 may read the program and supply the program to the CPU 1001.

There are various modifications of the implementation method of each device. For example, each device or system may be achieved by any combination of the information processing apparatus 1000 and the program separate for each component. A plurality of components included in each device may be achieved by any combination of one information processing apparatus 1000 and the program.

Some or all of the components of each device or system are achieved by a general-purpose or dedicated circuitry including a processor or the like, or a combination thereof. The circuitry is, for example, a CPU, a graphics processing unit (GPU), a field programmable gate array (FPGA), or a large scale integration (LSI) for artificial Intelligence (AI) processing. These may be configured by a single chip or may be configured by a plurality of chips connected via a bus. Some or all of the components of each device may be achieved by a combination of the above-described circuitry and the like and the program.

In a case where some or all of the components of each device or system are achieved by a plurality of the information processing apparatuses, circuits, and the like, the plurality of information processing apparatuses, circuits, and the like may be arranged in a centralized manner or in a distributed manner. For example, each of the information processing apparatuses, circuitry, or the like may be implemented in the form of a client server system, a cloud computing system, or the like in which they are connected to each other through a communication network.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

Although a plurality of operations is described in order in the form of a flowchart, the order of description does not limit the order of executing the plurality of operations. Therefore, in a case where each example embodiment is implemented, the order of the plurality of operations may be changed within a range that does not interfere with the content.

Some or all of the above-described example embodiments may be described as the following supplementary notes, but are not limited to the following.

### Supplementary Note 1

An information provision device including:
acquisition means for acquiring an image capturing a sales room for selling a product;
customer detection means for detecting a customer in the sales room based on the image;
stay degree specification means for specifying a degree of stay of the customer according to at least one of the number of stays, a staying time length, and the number of staying customers based on a detection result in a predetermined period up to the present;
position specification means for specifying a position where the degree of stay satisfies a predetermined condition; and
output means for outputting recommendation information indicating that a section around the position in the sales room is attracting attention.

### Supplementary Note 2

The information provision device according to Supplementary Note 1, in which
the recommendation information indicates that a section of a product shelf associated with the position is attracting attention.

### Supplementary Note 3

The information provision device according to Supplementary Note 1 or 2, in which
the position specification means specifies a plurality of the positions, and
the output means outputs a plurality of pieces of the recommendation information associated with the plurality of positions.

### Supplementary Note 4

The information provision device according to any one of Supplementary Notes 1 to 3, in which
the output means outputs preset information in a case where the customer is not detected from the image captured in the predetermined period.

### Supplementary Note 5

The information provision device according to any one of Supplementary Notes 1 to 4, in which
the output means outputs preset information until the predetermined period elapses from a time point at which a product is displayed.

### Supplementary Note 6

The information provision device according to any one of Supplementary Notes 1 to 5, in which
the output means outputs preset information in a case where the number of customers detected from the image captured in the predetermined period is equal to or less than a predetermined number.

### Supplementary Note 7

The information provision device according to any one of Supplementary Notes 1 to 6, further including:
reception means for receiving an inquiry from a customer; and
response means for determining a response to the inquiry.

### Supplementary Note 8

The information provision device according to Supplementary Note 7, in which
the reception means specifies information indicating an inquiry target based on information input by an input device,
the response means specifies information regarding an inquiry target associated with the information indicating the inquiry target, and
the output means outputs information regarding the inquiry target.

### Supplementary Note 9

The information provision device according to Supplementary Notes 7 or 8, in which
the response means determines, as the response to the inquiry, to establish a connection with a terminal device used by a product seller related to the inquiry target, and
the information provision device further includes:
connection destination specification means for specifying a product seller related to the inquiry target associated with information indicating the inquiry target; and
connection means for starting the connection with the terminal device used by the product seller.

### Supplementary Note 10

The information provision device according to Supplementary Note 9, in which
in a case where the information regarding the inquiry target is not stored in a storage unit, the connection means starts the connection with the terminal device used by the product seller regarding the inquiry target.

### Supplementary Note 11

The information provision device according to Supplementary Note 9 or 10, in which
the connection means stores, in a storage unit, sound information regarding the inquired target in the connection.

### Supplementary Note 12

The information provision device according to any one of Supplementary Notes 9 to 11, in which
the connection means stores text data based on sound in the connection, related to the inquired target in a storage unit.

### Supplementary Note 13

The information provision device according to any one of Supplementary Notes 7 to 12, further including
target specification means for specifying a target with a large number of inquiries from information regarding the inquiry by a customer, the information including information indicating the inquiry target, wherein
the output means outputs recommendation information indicating that the target with a large number of inquiries is attracting attention in the sales room.

### Supplementary Note 14

The information provision device according to Supplementary Note 13, in which
the target is a position in the sales room.

### Supplementary Note 15

The information provision device according to any one of Supplementary Notes 1 to 14, in which
the output means outputs the recommendation information in response to detection that a customer stays in the sales room.

### Supplementary Note 16

The information provision device according to any one of Supplementary Notes 1 to 15, in which
the output means outputs the recommendation information in response to detection that the customer looks at a terminal device used by the customer in the sales room.

### Supplementary Note 17

The information provision device according to any one of Supplementary Notes 1 to 16, in which
the output means outputs the recommendation information in response to detection that a customer has entered the sales room.

### Supplementary Note 18

An information provision method causing a computer to perform:
acquiring an image capturing a sales room for selling a product;
detecting a customer in the sales room based on the image;
specifying a degree of stay of the customer according to at least one of the number of stays, a staying time length, and the number of staying customers based on a detection result in a predetermined period up to the present;
specifying a position where the degree of stay satisfies a predetermined condition; and
outputting recommendation information indicating that a section around the position in the sales room is attracting attention.

### Supplementary Note 19

A recording medium storing a program for causing a computer to execute:
acquiring an image capturing a sales room for selling a product;

detecting a customer in the sales room based on the image;
specifying a degree of stay of the customer according to at least one of the number of stays, a staying time length, and the number of staying customers based on a detection result in a predetermined period up to the present;
specifying a position where the degree of stay satisfies a predetermined condition; and
outputting recommendation information indicating that a section around the position in the sales room is attracting attention.

### REFERENCE SIGNS LIST

100 information provision device
101 acquisition unit
102 customer detection unit
103 stay degree specification unit
104 position specification unit
105 output unit
200 information provision device
206 reception unit
207 response unit
208 connection destination specification unit
209 connection unit
200A information provision device
210 target specification unit
1000 information processing device
1001 CPU
1002 ROM
1003 RAM
1004 program
1005 storage device
1006 recording medium
1007 drive device
1008 communication I/F
1009 communication network
1010 input/output I/F
1011 bus

What is claimed is:

1. An information provision device comprising:
one or more memories storing instructions; and
one or more processors configured to execute the instructions to:
acquire an image capturing a sales room for selling a product;
detect a customer in the sales room based on the image;
specify a degree of stay of the customer according to at least one of the number of stays, a staying time length, and the number of staying customers based on a detection result in a predetermined period up to the present;
specify a position where the degree of stay satisfies a predetermined condition; and
output recommendation information indicating that a section around the position in the sales room is attracting attention.

2. The information provision device according to claim 1, wherein
the recommendation information indicates that a section of a product shelf associated with the position is attracting attention.

3. The information provision device according to claim 1, wherein the one or more processors configured to execute the instructions to:
specify a plurality of the positions, and
output a plurality of pieces of the recommendation information associated with the plurality of positions.

4. The information provision device according to claim 1, wherein the one or more processors configured to execute the instructions to:
output preset information in a case where the customer is not detected from the image captured in the predetermined period.

5. The information provision device according to claim 1, wherein the one or more processors configured to execute the instructions to:
output preset information until the predetermined period elapses from a time point at which a product is displayed.

6. The information provision device according to claim 1, wherein the one or more processors configured to execute the instructions to:
output preset information in a case where the number of customers detected from the image captured in the predetermined period is equal to or less than a predetermined number.

7. The information provision device according to claim 1, wherein the one or more processors further configured to execute the instructions to:
receive an inquiry from a customer; and
determine a response to the inquiry.

8. The information provision device according to claim 7, wherein the one or more processors configured to execute the instructions to:
specify information indicating an inquiry target based on information input by an input device,
specify information regarding the inquiry target associated with the information indicating the inquiry target, and
output information regarding the inquiry target.

9. The information provision device according to claim 7, wherein the one or more processors configured to execute the instructions to:
determine, as the response to the inquiry, to establish a connection with a terminal device used by a product seller related to an inquiry target:
specify a product seller related to the inquiry target associated with information indicating the inquiry target; and
start the connection with the terminal device used by the product seller.

10. The information provision device according to claim 9, wherein the one or more processors configured to execute the instructions to:
in a case where the information regarding the inquiry target is not stored in a storage unit, start the connection with the terminal device used by the product seller regarding the inquiry target.

11. The information provision device according to claim 9, wherein the one or more processors configured to execute the instructions to:
store, in the one or more memories, sound information regarding the inquired target in the connection.

12. The information provision device according to claim 9, wherein the one or more processors configured to execute the instructions to:
store text data based on sound in the connection, related to the inquired target in the one or more memories.

13. The information provision device according to claim 7, wherein the one or more processors further configured to execute the instructions to:
specify a target with a large number of inquiries from information regarding the inquiry by a customer, the information including information indicating the inquiry target: and
output recommendation information indicating that the target with a large number of inquiries is attracting attention in the sales room.

14. The information provision device according to claim 13, wherein the target is a position in the sales room.

15. The information provision device according to claim 1, wherein the one or more processors further configured to execute the instructions to:
output the recommendation information in response to detection that a customer stays in the sales room.

16. The information provision device according to claim 1, wherein the one or more processors further configured to execute the instructions to:
output the recommendation information in response to detection that the customer looks at a terminal device used by the customer in the sales room.

17. The information provision device according to claim 1, wherein the one or more processors further configured to execute the instructions to:
output the recommendation information in response to detection that a customer has entered the sales room.

18. An information provision method causing a computer to perform:
acquiring an image capturing a sales room for selling a product;
detecting a customer in the sales room based on the image;
specifying a degree of stay of the customer according to at least one of the number of stays, a staying time length, and the number of staying customers based on a detection result in a predetermined period up to the present;
specifying a position where the degree of stay satisfies a predetermined condition; and
outputting recommendation information indicating that a section around the position in the sales room is attracting attention.

19. A non-transitory recording medium storing a program for causing a computer to execute:
acquiring an image capturing a sales room for selling a product;
detecting a customer in the sales room based on the image;
specifying a degree of stay of the customer according to at least one of the number of stays, a staying time length, and the number of staying customers based on a detection result in a predetermined period up to the present;
specifying a position where the degree of stay satisfies a predetermined condition; and
outputting recommendation information indicating that a section around the position in the sales room is attracting attention.
